(19) United States
(12) Patent Application Publication
(10) Pub. No.: US 2023/0362658 A1
(43) Pub. Date: Nov. 9, 2023

(54) RADIO ACCESS NETWORK INTELLIGENT CONTROLLER (RIC) BASED RADIO RESOURCE ALLOCATION FOR NON-STANDALONE AND STANDALONE USERS

(71) Applicant: Cisco Technology, Inc., San Jose, CA (US)

(72) Inventors: Rajaneesh Sudhakar Shetty, Bangalore (IN); Rajiv Asati, Morrisville, NC (US); Soundarya Pendyala, Electronic City (IN); Arghya Mukherjee, Acton, MA (US)

(21) Appl. No.: 17/736,662

(22) Filed: May 4, 2022

(51) Int. Cl. H04W 16/10; H04W 36/16; H04W 76/12

(52) U.S. Cl. CPC H04W 16/10; H04W 36/165; H04W 76/12

(57) ABSTRACT

A method is provided for interchangeably allocating radio resources between a non-standalone (NSA) network and a standalone (SA) network in an overlapping area of coverage. The method may include monitoring utilization of radio resources of the SA network and the radio resources of the NSA network by a radio access network (RAN) intelligent controller (RIC). The method may also include determining that utilization of radio resources in one of the SA network or the NSA network is high by the RIC while utilization of radio resources in the other of the SA network or the NSA network having excess capacity. The method may also include reallocating radio resources from the one of the SA network or the NSA network having high radio resource utilization to the other of the SA network or the NSA network has excess capacity by the RIC.

### DESCRIPTION OF THE RELATED TECHNOLOGY

Fifth-generation (5G) mobile and wireless networks will provide enhanced mobile broadband communications and are intended to deliver a wider range of services and applications as compared to all prior generation mobile and wireless networks. Compared to prior generations of mobile and wireless networks, the 5G network architecture is service-based, meaning that wherever suitable, architecture elements are defined as network functions that offer their services to other network functions via common framework interfaces. The 5G networks or 5G core networks provide customers with higher data transfer speeds by pairing a 5G Radio Access Network (RAN) with the LTE Evolved Packet Core (EPC). Because the 5G RAN remains reliant on the 4G core network to manage control and signaling information and the 4G RAN continues to operate.

The 4G core network is referred to as a non-standalone architecture (NSA). By leveraging the existing infrastructure of the 4G core network, carriers can provide faster and more reliable Enhanced Mobile Broadband (eMBB) without completely reworking their core network technology and pushing customers to new devices. The 5G NSA provides a transitionary platform for carriers and customers alike.

The 5G core network is also referred to as a standalone architecture (SA). 5G SA does not depend on an LTE EPC to operate. Rather, the 5G SA pairs 5G radios with a cloud-native 5G core network. The 5G core network is designed as a Service-Based Architecture (SBA) which virtualizes network functions to provide the full range of 5G features an enterprise needs for factory automation, autonomous vehicle operation, and more.

### BRIEF DESCRIPTION OF THE DRAWINGS

To describe how the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1A depicts an example schematic representation of a 5G network environment in which network slicing has been implemented in accordance with some aspects of the disclosed technology;

FIG. 1B illustrates an example 5G network architecture in accordance with some aspects of the disclosed technology;

FIG. 2 illustrates an example 5G network including radio access network (RAN) intelligent controller (RIC) in communication with both non-standalone (NSA) and standalone (SA) networks in accordance with some aspects of the disclosed technology;

FIG. 3 is an example method for interchangeably allocating radio resources between an NSA network and an SA network in an overlapping area of coverage in accordance with some aspects of the disclosed technology;

FIG. 4 is a diagram illustrating a network architecture needing NSA resources from SA users in accordance with some aspects of the disclosed technology;

FIG. 5 is a diagram illustrating a network architecture needing SA resources from NSA users in accordance with some aspects of the disclosed technology;

FIG. 6A is an example sequence diagram depicting operations for allocating an NSA virtualized distributed unit (vDU) to provide additional bandwidth for SA users in accordance with some aspects of the disclosed technology;

FIG. 6B is a continuation of the example sequence diagram of FIG. 6B in accordance with some aspects of the disclosed technology;

FIG. 7 is a diagram illustrating an example 5G network architecture for 5G NSA and 5G SA deployments in accordance with some aspects of the disclosed technology;

FIG. 8 is a diagram illustrating an example network architecture including 4G core and 5G core and sharing resources in the same frequency band for NSA users and SA users in accordance with some aspects of the disclosed technology;

FIG. 9 is a diagram illustrating an example network architecture including 4G core and 5G core and having separate frequency bands allocated for SA users and NSA users within the NR in accordance with some aspects of the disclosed technology; and

FIG. 10 shows an example of computing system 1000 in accordance with some aspects of the disclosed technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained utilizing the instruments and combinations particularly pointed out in the appended claims. These and other features of the disclosure will become more fully apparent from the following description and appended claims or can be learned by the practice of the principles set forth herein.

The disclosed technology addresses the need in the art for interchangeably allocating radio resources between a non-standalone (NSA) network and a standalone (SA) network in an overlapping area of coverage. The present technology involves systems, methods, and computer-readable media for interchangeably allocating radio resources between a non-standalone (NSA) network and a standalone (SA) network in an overlapping area of coverage.

In many customer deployments, a service provider may serve both NSA users and SA users under the same gNB, but with different sets of frequencies or separate frequency bands for the NSA users and SA users.

The present technology provides solutions for the operator to re-purpose the frequency or frequency band between the NSA and SA users, which improves spectral efficiency and also for migration from the NSA network to the SA network or vice versa. The present technology provides a RIC-based mechanism to improve the spectral efficiency and dynamically share the distribution unit (DU) or radio unit (RU) software between NSA and SA based on the key performance indicators (KPIs).

### Overview

In one example, a method is provided for interchangeably allocating radio resources between a non-standalone (NSA) network and a standalone (SA) network in an overlapping area of coverage. The method may include monitoring the utilization of radio resources of the SA network and the radio resources of the NSA network by a radio access network (RAN) intelligent controller (RIC). The method may also include determining that utilization of radio resources in one of the SA network or the NSA network is high by the RIC while utilization of radio resources in the other of the SA network or the NSA network has excess capacity. The method may also include reallocating radio resources from one of the SA network or the NSA network having high radio resource utilization to the other of the SA network or the NSA network having excess capacity by the RIC.

In another example, a system can include a storage device configured to store instructions and one or more processors to execute the instructions and cause the one or more processors to monitor utilization of radio resources of the SA network and the radio resources of the NSA network by a radio access network (RAN) intelligent controller (MC). The system may also cause one or more processors to determine that utilization of radio resources in one of the SA network or the NSA network is high by the RIC while utilization of radio resources in the other of the SA network or the NSA network has excess capacity. The system may also cause one or more processors to reallocate radio resources from one of the SA network or the NSA network having high radio resource utilization to the other of the SA network or the NSA network having excess capacity by the MC.

In a further example, a non-transitory computer-readable storage medium having stored therein instructions which, when executed by a processor, cause the processor to monitor utilization of radio resources of the SA network and the radio resources of the NSA network by a radio access network (RAN) intelligent controller (RIC). The instructions can cause the processor to determine that utilization of radio resources in one of the SA network or the NSA network is high by the MC while utilization of radio resources in the other of the SA network or the NSA network has excess capacity. The instructions can also cause the processor to reallocate radio resources from the one of the SA network or the NSA network having high radio resource utilization to the other of the SA network or the NSA network having excess capacity by the MC.

### Example Embodiments

The present technology provides an algorithm involving configuration update procedures for virtualized control units (vCUs) and virtualized distributed units (vDUs), procedures for existing sessions handoff to vCUs, and re-configuration procedures for Radio Resource Control (RRC) connection.

The present technology also provides a hybrid working model for vDUs to support the vCUs of NSA or SA. The model provides vDUs support for both primary and secondary connections to vCUs with configurations ready and upon support switchover between the primary connection and the secondary connection when triggered by the MC.

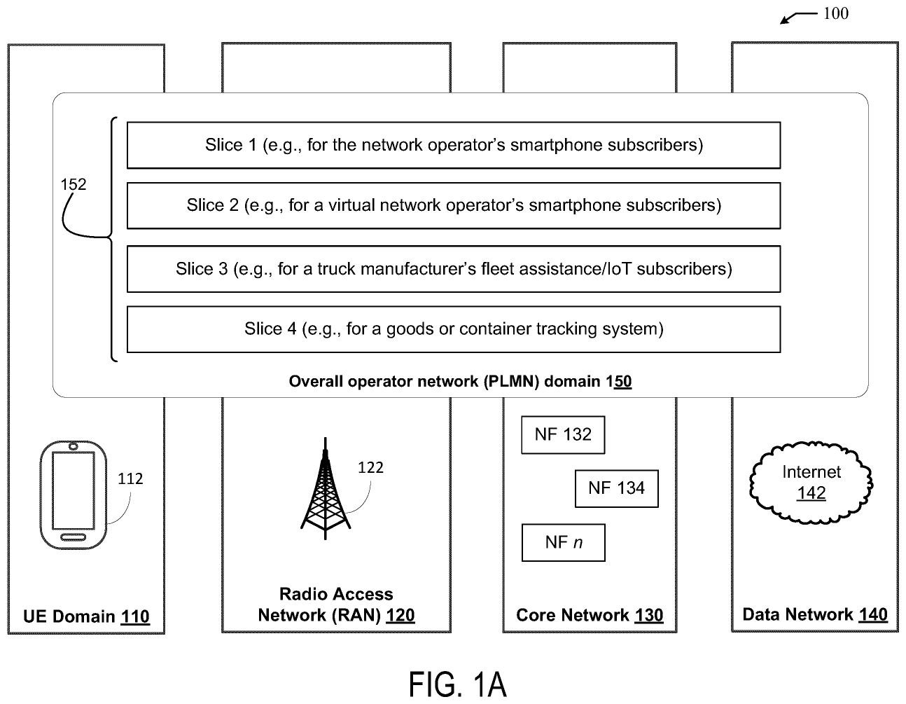

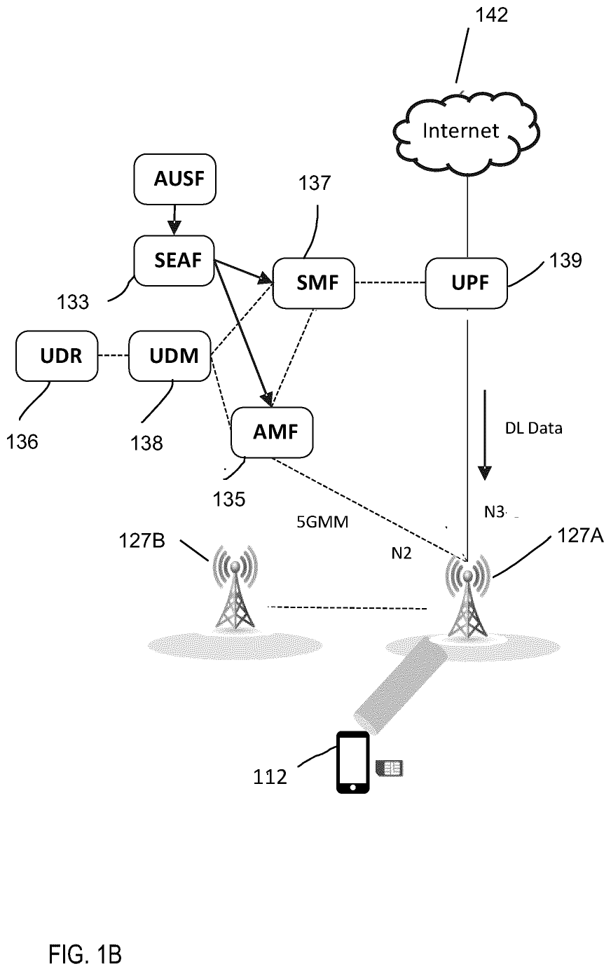

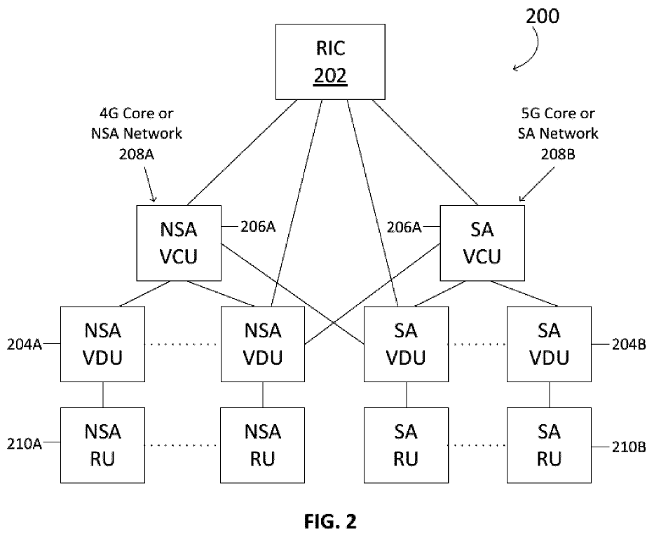

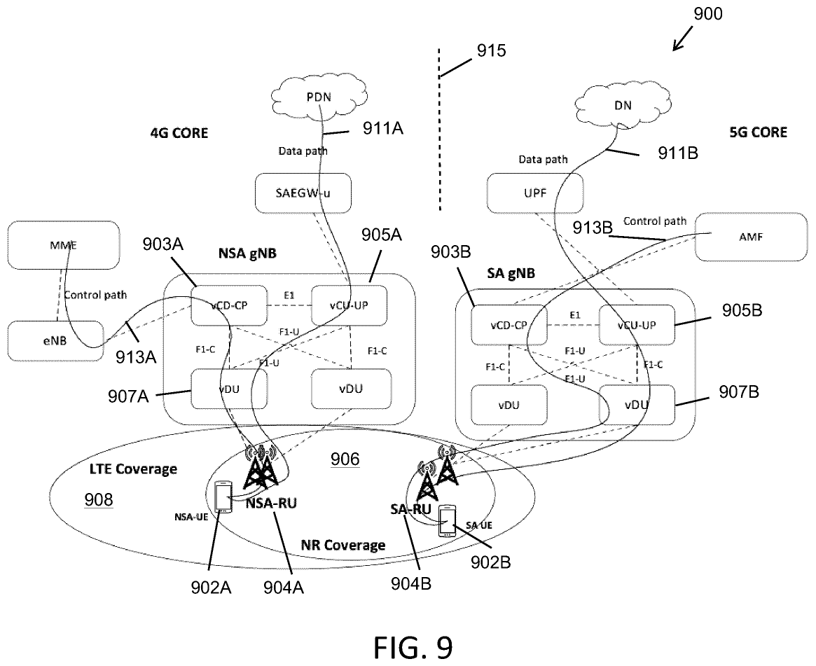

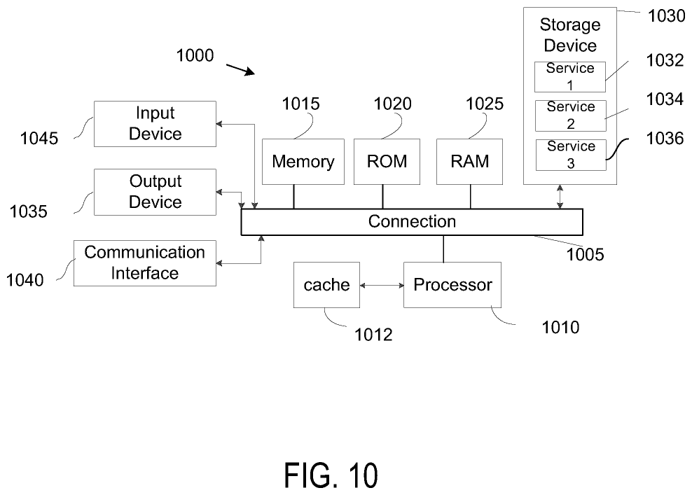

Descriptions of network environments and architectures for network data access and services, as illustrated in FIGS. 1A and 1B, are first disclosed herein. A discussion of the systems and methods for interchangeably allocating radio resources between a non-standalone (NSA) network and a standalone (SA) network in an overlapping area of coverage, as shown in FIGS. 2-8, will then follow. A discussion of a RAN deployment model using separate frequency bands for 4G core and 5G core networks, as shown in FIG. 9, will then follow as a comparison. The discussion then concludes with a brief description of example devices, as illustrated in FIG. 10. These variations shall be described herein as the various embodiments are set forth. The disclosure now turns to FIG. 1A.

FIG. 1A depicts an exemplary schematic representation of a 5G network environment in which network slicing has been implemented, and in which one or more aspects of the present disclosure may operate, according to some aspects of the present disclosure.

As illustrated, network environment 100 is divided into four domains, each of which will be explained in greater depth below; a User Equipment (UE) domain 110, e.g. of one or more enterprises, in which a plurality of user cellphones or other connected devices 112 reside; a Radio Access Network (RAN) domain 120, in which a plurality of radio cells, base stations, towers, or other radio infrastructure 122 resides; a Core Network 130, in which a plurality of Network Functions (NFs) 132, 134, . . . , n reside; and a Data Network 140, in which one or more data communication networks such as the Internet 142 reside. Additionally, the Data Network 140 can support SaaS providers configured to provide SaaSs to enterprises, e.g. to users in the UE domain 110.

Core Network 130 contains a plurality of Network Functions (NFs), shown here as NF 132, NF 134 . . . NF n. In some example embodiments, a core network 130 is a 5G core network (5GC) in accordance with one or more accepted 5GC architectures or designs. In some example embodiments, the core network 130 is an Evolved Packet Core (EPC) network, which combines aspects of the 5GC with existing 4G networks. Regardless of the particular design of core network 130, the plurality of NFs typically executes in a control plane of the core network 130, providing a service-based architecture in which a given NF allows any other authorized NFs to access its services. For example, a Session Management Function (SMF) controls session establishment, modification, release, etc., and in the course of doing so, provides other NFs with access to these constituent SMF services.

In some example embodiments, the plurality of NFs of the core network 130 can include one or more Access and Mobility Management Functions (AMF), typically used when core network 130 is a 5GC network) and Mobility Management Entities (MME), typically used when core network 130 is an EPC network), collectively referred to herein as an AMF/MME for purposes of simplicity and clarity. In some example embodiments, an AMF/MME can be common to or otherwise shared by multiple slices of the plurality of network slices 152, and in some example embodiments an AMF/MME can be unique to a single one of the plurality of network slices 152.

Similarly, the remaining NFs of the core network 130 can be shared amongst one or more network slices or provided as a unique instance specific to a single one of the plurality of network slices 152. In addition to NFs including an AMF/MME as discussed above, the plurality of NFs of the core network 130 can include one or more of the following: User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs). Various other NFs can be provided without departing from the scope of the present disclosure, as would be appreciated by one of ordinary skill in the art.

Across the four domains of the 5G network environment 100, an overall operator network domain 150 is defined. The operator network domain 150 is in some example embodiments a Public Land Mobile Network (PLMN), a private 5G network and/or a 5G enterprise network, and can be thought of as the carrier or business entity that provides cellular service to the end-users in UE domain 110. Within the operator network domain 150, a plurality of network slices 152 are created, defined, or otherwise provisioned to deliver the desired set of defined features and functionalities, e.g. SaaSs, for a certain use case or corresponding to other requirements or specifications. Note that network slicing for the plurality of network slices 152 is implemented in an end-to-end fashion, spanning multiple disparate technical and administrative domains, including management and orchestration planes (not shown). In other words, network slicing is performed from at least the enterprise or subscriber edge at UE domain 110, through the Radio Access Network (RAN) 120, through the 5G access edge and the 5G core network 130, and to the data network 140. Moreover, note that this network slicing may span multiple different 5G providers.

For example, as shown here, the plurality of network slices 152 include Slice 1, which corresponds to smartphone subscribers of the 5G provider who also operates network domain, and Slice 2, which corresponds to smartphone subscribers of a virtual 5G provider leasing capacity from the actual operator of network domain 150. Also shown is Slice 3, which can be provided for a fleet of connected vehicles, and Slice 4, which can be provided for an IoT goods or container tracking system across a factory network or supply chain. Note that the network slices 152 are provided for purposes of illustration, and in accordance with the present disclosure, and the operator network domain 150 can implement any number of network slices as needed, and can implement these network slices for purposes, use cases, or subsets of users and user equipment in addition to those listed above. Specifically, the operator network domain 150 can implement any number of network slices for provisioning SaaSs from SaaS providers to one or more enterprises.

5G mobile and wireless networks will provide enhanced mobile broadband communications and are intended to deliver a wider range of services and applications as compared to all prior generation mobile and wireless networks. Compared to prior generations of mobile and wireless networks, the 5G network architecture is service-based, meaning that wherever suitable, architecture elements are defined as network functions that offer their services to other network functions via common framework interfaces. To support this wide range of services and network functions across an ever-growing base of user equipment (UE), 5G networks incorporate the network slicing concept utilized in previous generation architectures.

Within the scope of the 5G mobile and wireless network architecture, a network slice includes a set of defined features and functionalities that together form a complete Public Land Mobile Network (PLMN), a private 5G network and/or a 5G enterprise network for providing services to UEs. This network slicing permits for the controlled composition of the 5G network with the specific network functions and provided services that are required for a specific usage scenario. In other words, network slicing enables a 5G network operator to deploy multiple, independent 5G networks where each is customized by instantiating only those features, capabilities, and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise requests network slices when registering with AMF/MME for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g. based on requirements of the services, to the enterprise.

Associating SaaSs and SaaS providers with network slices used to provide the SaaSs to enterprises can facilitate efficient management of SaaS provisioning to the enterprises. Specifically, it is desirable for an enterprise/subscriber to associate already procured SaaSs and SaaS providers with network slices being used to provision the SaaSs to the enterprise. However, associating SaaSs and SaaS providers with network slices is extremely difficult to achieve without federation across enterprises, network service providers, e.g. 5G service providers, and SaaS providers.

FIG. 1B illustrates an example 5G network architecture. As addressed above, a User Equipment (UE) 112 can connect to a radio access network provided by a first gNodeB (gNB) 127A or a second gNB 127B.

The gNB 127A can communicate over a control plane N2 interface with an access mobility function (AMF) 135. AMF 135 can handle tasks related to network access through communication with unified data management (UDM) function 138 which accesses a user data repository (URD) 136 that can contain user data such as profile information, authentication information, etc. Collectively AMF 135 and UDM 138 can determine whether a UE should have access and any parameters on access. AMF 135 also works with SEAF 133 to handle authentication and re-authentication of the UE 112 as it moves between access networks. The SEAF and the AMF could be separated or co-located.

Assuming AMF 135 determines the UE 112 should have access to a user plane to provide voice or data communications, AMF 135 can select one or more service management functions (SMF) 137. SMF 137 can configure and control one or more user plane functions (UPF) 139. Control plane communications between the SMF 137 and the gNB 127A (or 127B) also need to be encrypted. SEAF 133 can provide a security key to SMF 137 for use in encrypting control plane communications between the SMF 137 and the gNB 127A (or 127B).

As noted above SMF 137 can configure and control one or more user plane functions (UPF) 139. SMF 137 communicates with UPF 139 over an N4 Interface which is a bridge between the control plane and the user plane. SMF 137 can send PDU session management and traffic steering and policy rules to UPF 139 over the N4 interface. UPF 139 can send PDU usage and event reporting to SMF 137 over the N4 interface.

UPF 139 can communicate user plane data or voice over the N3 interface back to UE 112 through gNB 127A. There can be any number of UPFs handling different user plane services. Most commonly there would be at least one UPF for data service and at least one UPF for voice service.

By implementing UPF at each gNB, many UPF instances are in a single deployment, which complicates the UE IP address management and user plane data forwarding. Typically, a UE IP address pool is maintained by SMF, which allocates an IP address to a UE during UE Registration/PDU (Protocol Data Unit) session establishment process. SMF then configures UPF with traffic classification rules and traffic policies for the IP address. UPF acts as a router for the subnet allocated to the UE. IGP/BGP protocols can be used to publish these routes into the network. When the traffic for the UE is received from the network, the traffic is classified and the IP payload alone is forwarded to the gNB where the UE is connected over a GTPu tunnel. Similarly, when data are received in an uplink over the GTPu tunnel, UPF appends a MAC header and routes the data to the next hop. In the context of local UPF collocated at a gNB, maintaining one UE IP address pool per gNB will not be scalable and manageable as multiple gNBs exist in a facility. Routing/Packet forwarding would have similar implications.

FIG. 2 illustrates an example 5G network including radio access network (RAN) intelligent controller (RIC) in communication with both NSA and SA networks in accordance with some aspects of the disclosed technology. As shown in FIG. 2, a 5G core network 200 includes an NSA network or architecture 208A and an SA network or architecture 208B. Two deployment modes are used for 5G networks, i.e. NSA and SA, to help manage the migration of cellular networks from LTE to the 5G New Radio (NR) standard.

In contrast, the 5G core network is referred to as a standalone architecture (SA). 5G SA does not depend on an LTE EPC to operate. Rather, the 5G SA pairs 5G radios with a cloud-native 5G core network. The 5G core network is designed as a Service-Based Architecture (SBA) which virtualizes network functions to provide the full range of 5G features an enterprise needs for factory automation, autonomous vehicle operation, and more.

The main difference between NSA and SA is that the NSA anchors the control signaling of 5G Radios to the 4G core network, while the SA connects the 5G Radios directly to the 5G core network, and the control signaling does not depend on the 4G core network.

The 5G core network 200 also includes a RIC 202, which is in communication with multiple NSA-vDUs 204A and a NSA-vCU 206A in the NSA network 208A. The RIC 202 is a key component in the management of 5G network functions like network slicing, high-bandwidth, low-latency applications, prioritized communications and more. The RIC 202 is an essential component in an Open RAN architecture. The RIC 202 is also in communication with multiple SA-vDUs 204B and a SA-vCU 206B in the SA network 208B.

The RIC 202 can monitor loads of both the SA-vDUs and the NSA-vDUs. For example, the RIC 202 can detect the overload of one of the two technologies, e.g. SA or NSA. The RIC 202 can also identify vDUs from another technology and help recover from the overload situations. In particular, the RIC 202 can detect the load of NSA-vDUs and SA-vDUs and can also identify the need for additional vDUs for either SA users or NSA users by monitoring KPIs, i.e. Physical Resource Block PRB) utilization, quality of service (QoS), latency, coverage, and a number of active users, among others.

The RIC 202 may also ensure that releasing vDUs from SA or NSA would not cause congestion on the existing associated network. The MC 202 can also allocate resources between the SA network and the NSA network.

As illustrated in FIG. 2, one vCU may control multiple vDUs, which are physical layers or different frequency layers at various sites. For example, one SA-vCU may control multiple SA vDUs. Likewise, one NSA-vCU may control multiple NSA vDUs. One or more SA-vDUs may be allocated to be NSA-vDUs for NSA users. Similarly, one or more NSA vDUs may be allocated to be SA vDUs for SA users. Also, the SA-vCU may control one or more NSA-vDUs. Likewise, the NSA-vCU may control one or more SA-vDUs.

As illustrated, each vDU is in communication with a respective radio unit (RU) 210A or 210B. For example, the NSA-vDUs connect to the respective NSA-RUs while the SA-vDUs connect to the respective SA-RUs.

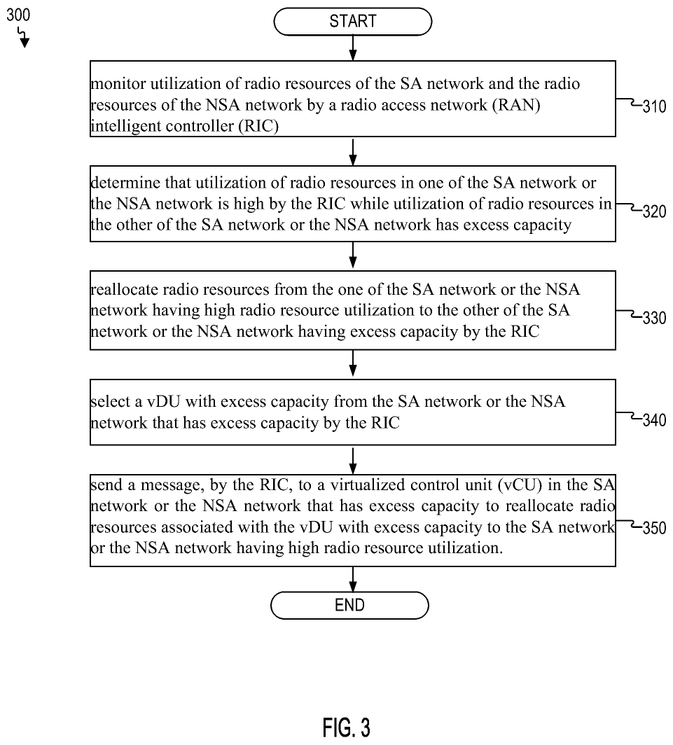

FIG. 3 illustrates an example method 300 for interchangeably allocating radio resources between an NSA network and an SA network in an overlapping area of coverage in accordance with some aspects of the disclosed technology. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, method 300 may include monitoring utilization of radio resources of the SA network and the radio resources of the NSA network by a RIC at operation 310. For example, the MC 202 illustrated in FIG. 2 may monitor the utilization of radio resources of the SA network and the radio resources of the NSA network.

Method 300 can interchangeably allocate radio resources for NSA users and SA users in an overlapping area of coverage. The SA network or 5G core network may include an SA-gNB, an SA-RU, one or more SA-vDUs, and one or more SA-vCUs. The NSA network or 4G core network may include an NSA-gNB, an NSA-RU, one or more NSA-vDUs, and one or more NSA-vCUs. The SA-RU and the NSA-RU are in the NR coverage overlapped with the LTE coverage. The RIC is configured to detect the overload of the NSA users and the SA users. The SA-gNB and the NSA-gNB are configured to dynamically share the SA-RU and NSA-RU for the SA users and NSA users.

The RIC 202 monitors the vDU load for both NSA and SA users regularly. In some aspects, the utilization of radio resources of the SA network and the radio resources of the NSA network by a RIC may be monitored based upon KPIs. The RIC 202 may detect a need for additional bandwidth for one of NSA users and SA users based upon KPI and send instructions to one of SA-vCUs or NSA-vCUs for dynamically allocating a frequency bandwidth to one of the SA users or the NSA users for interchangeably providing additional bandwidth to one of the NSA users or the SA users when one of the NSA users or SA users needs additional bandwidth.

According to some examples, method 300 may include determining that utilization of radio resources in one of the SA network or the NSA network is high while utilization of radio resources in the other of the SA network or the NSA network has excess capacity at operation 320. For example, the RIC 202 illustrated in FIG. 2 may determine that utilization of radio resources in one of the SA network or the NSA network is high while utilization of radio resources in the other of the SA network or the NSA network has excess capacity.

High utilization of radio resources can result in a decline in a quality of service (QoS) for connected user equipment (UE), or in a reduced ability to support additional UE connections. For example, the SA network 208B may have a higher demand for radio resources than the NSA network 208A, which may have excess capacity. Alternatively, the NSA network 208A may have a higher demand for radio resources than the SA network, which may have excess capacity or additional bandwidth. The radio resources may be reallocated between the SA and NSA networks.

In some aspects, the utilization of the radio resources is a load on a vDU in the SA network 208B and the NSA network 208A. The MC 202 may select a vDU 204B or 204A with excess capacity from the SA network or the NSA network, respectively, that has excess capacity by the RIC 202 and send a message to a vCU 206B or 206A in the SA network 208B or the NSA network 208A, respectively, that has excess capacity to reallocate radio resources associated with the vDU with excess capacity to the SA network 208B or the NSA network 208A having high radio resource utilization.

According to some examples, method 300 may include reallocating radio resources from the one of the SA network or the NSA network having high radio resource utilization to the other of the SA network or the NSA network having excess capacity at operation 330. For example, the RIC 202 illustrated in FIG. 2 may reallocate radio resources from the one of the SA network or the NSA network having high radio resource utilization to the other of the SA network or the NSA network having excess capacity.

In some aspects, the reallocation of radio resources associated with the vDU with excess capacity may include allocating a portion of the frequency band utilized by the vDU with excess capacity to an updated vDU instantiated in the SA network or the NSA network having high radio resource utilization.

In some aspects, the reallocation of radio resources associated with the vDU with excess capacity may include instructing the vDU with excess capacity to switch its connection from the vCU in the SA network or the NSA network that has excess capacity to a vCU in the SA network or the NSA network having high radio resource utilization.

In some aspects, the method may include releasing one of the SA-vDUs or NSA-vDUs to one of the NSA users or SA users.

In some aspects, the vDU in the SA network may be configured to establish a primary connection to the vCU in the SA network and a secondary connection vCU in the NSA network. The reallocation of the radio resources may include switching the vDU in the SA network from its primary connection to the vCU in the SA network to its secondary connection to the vCU in the NSA network, whereby the secondary connection becomes an updated primary connection.

In some aspects, the vDU in the NSA network may be configured to establish a primary connection to the vCUs in the NSA network and a secondary connection to the vCU in the SA network. The reallocation of the radio resources may include switching the vDU in the NSA network from its primary connection to the vCU in the NSA network to its secondary connection to the vCU in the SA network, whereby the secondary connection becomes an updated primary connection.

According to some examples, method 300 may include selecting a vDU with excess capacity from the SA network or the NSA network that has excess capacity at operation 340. For example, the RIC 202 illustrated in FIG. 2 may select a vDU with excess capacity from the SA network or the NSA network that has excess capacity.

Method 300 provides RIC-based fairness between 5G SA users and 5G NSA users. For example, when there is a need for additional bandwidth for SA users in an SA domain, the RIC 202 selects the least loaded vDU in an NSA domain and initiates the process for the selected least loaded vDU of the NSA to connect to the vCU of the SA as a secondary connection.

According to some examples, method 300 may include sending a message to a vCU in the SA network or the NSA network that has excess capacity to reallocate radio resources associated with the vDU with excess capacity to the SA network or the NSA network having high radio resource utilization at operation 350. For example, the RIC 202 illustrated in FIG. 2 may send a message to the vCU in the SA network or the NSA network that has excess capacity to reallocate radio resources associated with the vDU with excess capacity to the SA network or the NSA network have high radio resource utilization.

The RIC 202 also releases a primary connection of the selected least loaded vDU of the NSA to the vCU of the NSA or NSA-vCU, thereby adding more bandwidth to the SA domain. The MC 202 also indicates that the vCU from the NSA domain or NSA-vCU does not allocate any more NSA users to the selected NSA-vDU.

The NSA-vCU initiates handover to the existing sessions supported by NSA-vCU to the neighboring NSA-vDUs if possible. Once all the sessions are handed over, the NSA-vCU initiates the secondary connection and marks it as a new primary connection or an updated primary connection, and marks a previous primary connection towards NSA-vDU as a new secondary connection or an updated secondary connection. The NSA-vCU then indicates back to the RIC upon completion of the activity. The RIC upon receiving the acknowledgment from the NSA-vDU indicates the vCU of the SA domain to allocate the NSA-vDU for SA users.

In some aspects, the vCU (e.g. SA-vCU or NSA-vCU) may receive the message from the RIC and may initiate a handover of existing sessions supported by the vDU (e.g. SA-vDU or NSA-vDU) with excess capacity in the SA network or the NSA network that has excess capacity to another vDU in the SA network or the NSA network that has excess capacity. The vCU may perform a Radio Resource Control (RRC) connection reconfiguration of the vDU with excess capacity to the SA network or the NSA network having high radio resource utilization.

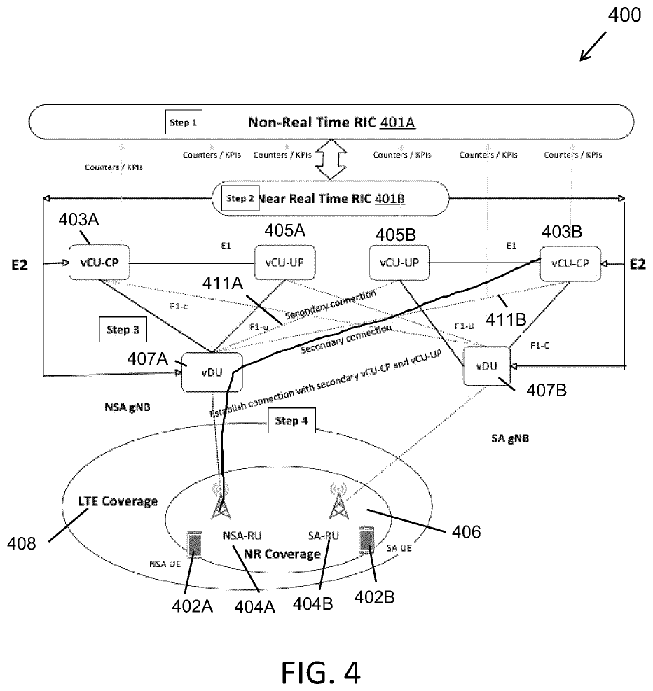

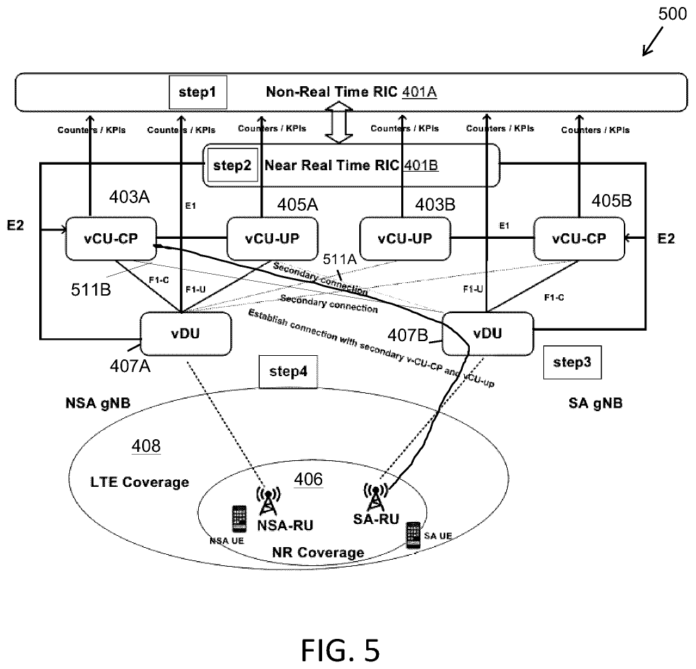

Method 300, as illustrated in FIG. 3, will also be discussed in the context of FIGS. 4 and 5, which illustrate a first scenario for allocating an NSA-vDU to provide additional bandwidth for SA users in FIG. 4 and a second scenario for allocating an SA-vDU to provide additional bandwidth for NSA users in FIG. 5.

When there is a need for NSA resources in an area, the vDUs and RUs of NSA are re-purposed to connect to vCUs of SA to provide the additional bandwidth to SA users. FIG. 4 is a diagram illustrating a network architecture needing NSA resources from SA users in accordance with some aspects of the disclosed technology.

As illustrated in FIG. 4, a network architecture 400 may include an NSA gNB 409A may include NSA Radio Unit (RU) 404A, NSA-vDU 407A, NSA-vCU-CP 403A, and NSA-vCU-UP 405A. The network architecture 400 may also include an SA gNB 409B may include SA-RU 404B, SA-vDU 407B, SA-vCU-CP 403B, and SA-vCU-UP 405B.

The SA gNB and NSA gNB are used for 5G SA and 5G NSA networks and allow 5G users (UEs) to connect with 5G core using 5G NR air interface. The gNBs provide 5G NR User Plane (UP) and Control Plane (CP) terminations towards UE. The gNBs connect with NG-Core via NG interface. The RUs can convert radio signals to digital signals that can be transmitted.

The vCU-CP 403B has an interface E1 with the vCU-UP 405B. Similarly, the vCU-CP 403A has an interface E1 with the vCU-UP 405A. Also, the vDU 407A has an interface F1-U with the vCU-UP 405A and an interface F1-C with the vCU-CP 403A. Similarly, the vDU 407B has an interface F1-U with the vCU-UP A 405B, and an interface F1-C with the vCU-CP 403B. The near-RT MC 401B has an interface E2 to the NSA-vDU 407A or SA-vDU 407B.

The network architecture 400 includes the MC 202, which may include a non-real-time (RT) MC 401A, which may detect that the 5G SA users may need additional bandwidth in the coverage area based upon the KPIs at step 1. The non-RT MC 401A may handle all the configurations and monitor the KPIs, which may be collected from the SA-vDUs or NSA-vDUs. The non-RT MC 401A may operate in the order of hundreds of milliseconds.

The RIC 202 may include a near-RT RIC 401B, which may handle all the needs with very fast responses, for example, less than the latency of 10 milliseconds. The near-RT RIC 401B may operate at a latency up to about 20 milliseconds. One may re-adjust or re-purpose the frequency within a full frequency bandwidth, for example, a portion of the full frequency bandwidth.

When operation 340 of selecting a vDU with excess capacity from the NSA network and operation 350 of sending a message to a vCU in the SA network are complete, the selected vDU of the NSA or NSA-vDUs with the least load or excess capacity start to use their secondary connections with SA-vCUs as new or updated primary connections and mark their previous primary connections with NSA-vCUs as new or updated secondary connections at step 2. The NSA-vDUs have primary connections to NSA-vCUs. When there is a need for NSA resources for SA users, the NSA-vDUs are configured to establish secondary connections to SA-vCUs.

The non-RT RIC 401A instructs the near-RT RIC 401B to pass on the configuration to one of the NSA-vDUs to establish a connection with the SA-vCU at step 3. For example, the NSA-vDU 407A establishes a secondary connection 411A with vCU-UP 405B. The NSA-vDU 407A establishes a secondary connection 411B with vCU-CP 403B.

When operation 330 of reallocating radio resources from the NSA network or NSA domain to the SA network or SA domain is completed, the NSA-RU 404A and NSA-vDU 407A are associated with the SA-vCU-CP 403A and start catering to the 5G SA users 402B in the region to provide more bandwidth to the 5G SA users 402B at step 4.

When there is a need for SA resources in an area, the vDUs and RUs of SA are re-purposed to connect to vCUs of NSA to provide the required bandwidth to NSA users. FIG. 5 is a diagram illustrating a network architecture needing SA resources from NSA users in accordance with some aspects of the disclosed technology.

A network architecture 500 includes similar elements to architecture 400 but illustrates different steps 1-4 from the network architecture 400. As illustrated in FIG. 5, the non-real-time RIC 401A detects that the 5G NSA users need more bandwidth in the coverage area based upon the KPIs at step 1. The non-RT RIC 401A instructs the near-RT MC 401B to pass on the configuration to some of the SA-vDUs to establish a secondary connection with the NSA-vCUs at step 2.

When operation 340 of selecting a vDU with excess capacity from the SA network and operation 350 of sending a message to a vCU in the NSA network are complete, the selected SA-vDUs start using their secondary connections with the NSA-vCUs as updated or new primary connections and mark their previous primary connections with SA-vCUs as secondary connections at step 3. The SA-vDUs have primary connections to SA-vCUs. When there is a need for SA resources for NSA users, the SA-vDUs are configured to establish secondary connections to NSA-vCUs. For example, the SA-vDU 407B establishes a secondary connection 511A with NSA-vCU-UP 405A. The SA-vDU 407B also establishes a secondary connection 511B with NSA-vCU-CP 403A.

When operation 330 of reallocating radio resources from the SA network or SA domain to the NSA network or NSA domain is completed, the SA-RU and SA-vDU are associated with NSA-vCU and starts supporting the 5G NSA users in the region to provide more bandwidth to the 5G NSA users at step 4.

As illustrated in FIGS. 4 and 5, the SA-vDU or NSA-vDU can connect to one of the NSA-RU or SA-RU. The SA-vDU or NSA-vDU cannot connect to both the NSA-RU and SA-RU simultaneously.

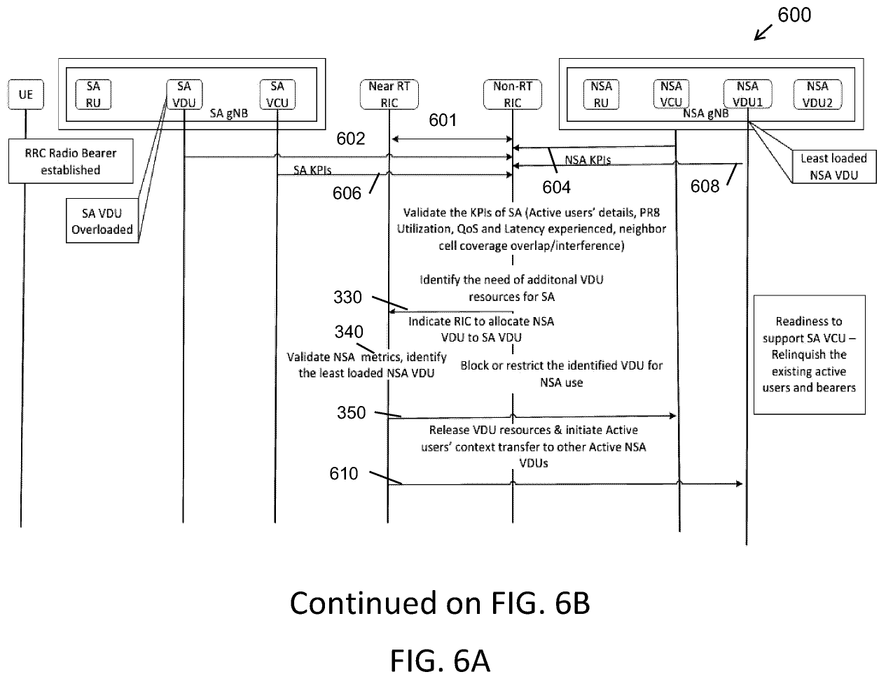

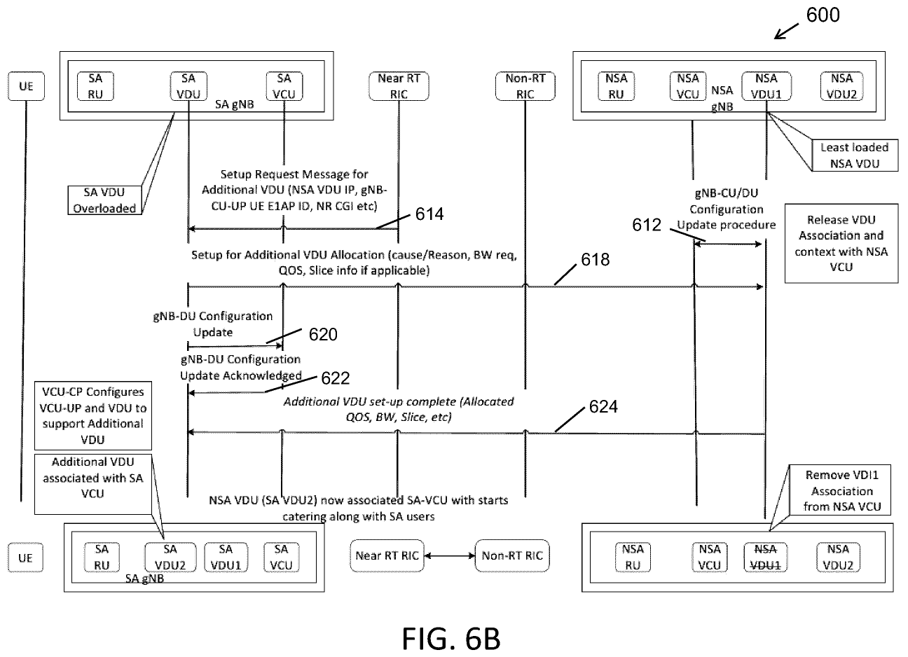

Method 300, as illustrated in FIG. 3, will also be discussed in the context of FIGS. 6A-B, which illustrate a sequence diagram for allocating an NSA virtualized distributed unit (vDU) to provide additional bandwidth for SA users. Some steps specific to the present technology illustrated in method 300 are also present in FIGS. 6A-B, for example, operations 310, 320, 330, 340, and 350 are also present in FIGS. 6A-B.

FIGS. 6A-B are an example sequence diagram depicting operations for allocating an NSA virtualized distributed unit (vDU) to provide additional bandwidth for SA users in accordance with some aspects of the disclosed technology. As described in related texts to FIG. 2, RIC periodically monitors the KPIs of SA-vDUs and NSA-vDUs.

As illustrated in FIGS. 6A-B, operation 302 includes steps 602, 604, 606, and 608. During operation 310 of monitoring utilization of radio resources of the SA network and the radio resources of the NSA network by a RIC, as illustrated in FIG. 3, the non-RT RIC 401A validates the KPIs of SA, including active users' details, PRB utilization, QoS, latency experienced, and neighboring cell coverage overlap or interference, among others. Specifically, at step 601, the non-RT RIC 401A establishes communication with the near-RT MC 401B. At step 602, the non-RT RIC 401A receives the load of SA-vDU 407B from the SA-vDU 407B. At step 604, the non-RT RIC 401A receives the load of NSA-vDU 407A from the NSA-vDU 407A. At step 606, the non-RT RIC 401A receives the KPIs from the SA-vCU 403B. At step 608, the non-RT RIC 401A receives the KPIs from the NSA-vCU 403A.

During operation 320 of determining that utilization of radio resources in one of the SA network or the NSA network is high by the MC while utilization of radio resources in the other of the SA network or the NSA network has excess capacity, as illustrated in FIG. 3, the non-RT MC 401A identifies the need of additional vDU resources for SA users based upon the metrics collected.

During operation 330 of reallocating radio resources from the one of the SA network or the NSA network having high radio resource utilization to the other of the SA network or the NSA network having excess capacity by the RIC, as illustrated in FIG. 3, the non-RT MC indicates to the near-RT RIC 401B to allocate an additional NSA-vDU to SA-vCU.

During operation 340 of selecting a vDU with excess capacity from the SA network or the NSA network that has excess capacity by the MC, as illustrated in FIG. 3, the near-RT MC validates the NSA metrics and identifies the least loaded NSA-vDU associated with the NSA-vCU. The MC 401 identifies NSA-vDU1 as the least loaded and initiates NSA-vCU to prepare for disassociation.

During operation 350 of sending a message, by the RIC, to a virtualized control unit (vCU) in the SA network or the NSA network that has excess capacity to reallocate radio resources associated with the vDU with excess capacity to the SA network or the NSA network having high radio resource utilization, as illustrated in FIG. 3, the near-RT MC 401B sends a message to NSA-vCU to block or restrict the identified NSA-vDU for NSA users.

At step 610, the near-RT RIC 401B sends a message to NSA-vDU1 to release NSA-vDU resources and initiates active users' context transfer to other active NSA-vDUs. Now, the readiness to support SA-vCU has been achieved. Also, the existing active users and bearers have been relinquished or given up.

At step 612, the configuration for gNB, CU, and DU is updated to release NSA-vDU1's association and context with the NSA-vCU. In other words, the NSA-vCU releases the existing active users and bearers from NSA-vDU1 and performs existing context transfers to SA-vDU2.

At step 614, the near-RT RIC 401B sends a signal to the SA-vCU for preparing the association of the additional vDU (e.g. SA-vDU2).

At step 618, the SA-vDU 403B informs the NSA-vDU1 to set up for allocation of the additional vDU, including providing cause or reason, bandwidth requirement, QoS, slice information if applicable, among others.

Next, the SA-vCU-CP configures SA-vCU-UP and SA-vDU to support an additional vDU (e.g. SA-vDU2). At step 620, the SA-vDU sends a gNB-DU configuration update to the SA-vCU. At step 622, the SA-vCU sends a gNB-DU configuration update to acknowledge to the SA-vDU.

At step 624, NSA-vDU1 messages to the SA-vDU that the additional vDU set-up is complete, including allocated QoS, frequency bandwidth, slice, among others. Now, the SA-vCU carries out an additional SA-vDU2, i.e. NSA-vDU1 is configured to be the SA-vDU2, and SA-vCU is now associated with the SA-vDU2. As such, NSA-vDU1 (i.e. SA-vDU2) is associated with the SA-vCU. The SA-vDU2 starts supporting the SA users.

In summary, when there is a need for additional bandwidth for the SA users, a method may include monitoring, by the RIC, loads of SA-vDUs and NSA-vDUs for both NSA users and SA users; selecting, by the RIC, the least loaded NSA-vDU; and sending a message to the NSA-vCU to initiate the selected least loaded NSA-vDU to connect to the SA-vCU as a secondary connection. The method may also include receiving the message from the RIC and initiating a handover, by the NSA-vCU, to existing sessions catered by neighboring NSA-vDUs, establishing the secondary connection, by the NSA-vCU, marking the secondary connection as an updated primary connection, by the NSA-vCU to release the primary connection from the NSA-vDU to the NSA-vCU, marking the primary connection to the NSA DUs as an updated secondary connection to block the NSA-vCU from allocating more NSA users to the selected least loaded NSA-vDU, and informing the RIC the connection of SA-vCU to the selected least loaded NSA-vDU to add additional bandwidth to the SA users. The SA-vDU is configured to switch between supporting the NSA users and the SA users and to share the one or more vDUs between the NSA users and the SA users.

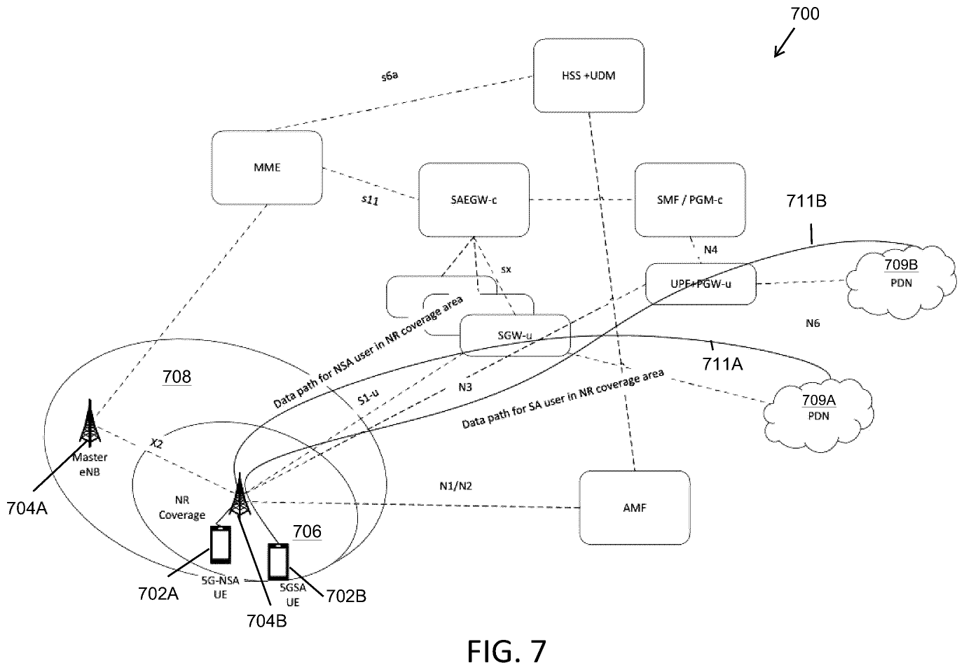

FIG. 7 is a diagram illustrating an example 5G network architecture for 5G NSA and 5G SA deployments in accordance with some aspects of the disclosed technology. In a 5G network architecture 700, resources in an NR coverage 706 in an overlapping region with LTE coverage 708 can be re-used for both NSA users and SA users. For example, a 5G gNB 704B within the NR coverage 706 can be shared for 5G NSA users 702A and 5G SA users 702B. Also, the SA users and the NSA users interchangeably and dynamically share the same frequency band in the network architecture 700. In the 5G network architecture 700, the 5G NSA users in the NR coverage have one data path 711A to PDN 709A, while the 5G SA users 702B in the NR coverage have another data path 711B to PDN 709B.

The network architecture 700 may also include a master eNB 704A within the LTE coverage 708. The master eNB 704A connects to MME, which connects to HSS+UDM via interface s6a. The MME also connects to SAEGW-c via interface S11. As illustrated, HSS+UDM connects to AMF, which connects to the gNB 704B via interface N1 or N2. SAEGW-c has an interface Sx to SGW-u, which connects to the gNB 704B via interface S1-u.

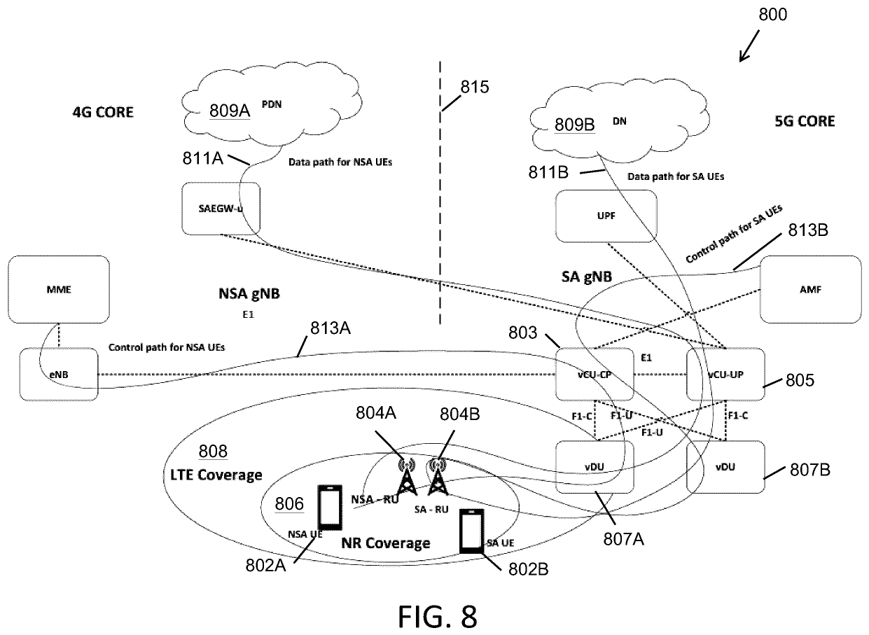

FIG. 8 is a diagram illustrating an example network architecture including 4G core and 5G core and sharing resources in the same frequency band for NSA users and SA users in accordance with some aspects of the disclosed technology. As illustrated in FIG. 8, a network architecture 800 configures a 5G core and a 4G core to support both NSA and SA users in a common NR coverage 806. The 5G core is an SA network on the right side of a vertical dashed line 815, while the 4G core is an NSA network on the left side of the vertical dashed line 815. The network architecture 800 allows improved usage of the resources across the NSA and SA networks. In the network architecture 800, the SA users 802B and the NSA users 802A share the same frequency band.

As illustrated in FIG. 8, in a 5G network architecture 800, resources in the NR coverage 806 in an overlapping region with LTE coverage 808 can be re-used or reallocated for both NSA users and SA users. For example, NSA gNB 804A and SA 804B within the NR coverage 806 can be shared for 5G NSA users 802A and 5G SA users 802B.

As illustrated in FIG. 8, the network architecture 800 may include a data path 811A from the NSA-RU to PDN 809A via vDU 807A, vCU-UP 805, and SAEGW-u for NSA users 802A. The network architecture 800 may include another data path 811B from the SA-RU to DN 809B via another vDU 807B, the vCU-UP 805 and UPF for SA users 802B.

The network architecture 800 may also include a control path 813A from the NSA-RU to MMB via the vDU 807A, the vCU-CP 803, and the eNB for NSA users 802A. The network architecture 800 may also include a control path 813B from the SA-RU to AMF via the other vDU 807B, the vCU-CP 803 for SA users 802B.

As illustrated in FIG. 8, the SA-vDU or NSA-vDU can connect to one of the NSA-RU or SA-RU. The SA-vDU or NSA-vDU cannot connect to both the NSA-RU and SA-RU simultaneously.

The network architecture 800 provides solutions to a common or shared scheduler for both SA and NSA users using both 5G SA services and 5G NSA services. The network architecture 800 may also reduce 5G-related capital expenditure (CAPEX) for operators.

In some aspects, a first data path may be established for the SA users by connecting the SA-RU to a data network (DN) in the 5G core network through a first SA-vDU and a first SA-vCU that connects between the first SA-vDU and the DN. A second data path may be established for the NSA users by connecting the NSA-RU to a public data network (PDN) in the 4G core network through a second SA-vDU.

In some aspects, a first data path may be established for the NSA users by connecting the NSA-RU to a PDN in the 4G core network through a first NSA-vDU and a first SA-vCU that connects between the first SA-vDU and the PDN. A second data path may be established for the SA users by connecting the SA-RU to a DN in the 5G core network through a second NSA-vDU.

FIG. 9 is a diagram illustrating an example network architecture including 4G core and 5G core and having separate frequency bands allocated for SA users and NSA users within the NR in accordance with some aspects of the disclosed technology. As illustrated in FIG. 9, a RAN deployment model 900 is used in a common NR coverage 906 for 5G SA and 5G NSA services, where separate frequencies are allocated to 5G SA and 5G NSA users within the common NR coverage 906.

As illustrated in FIG. 9, the RAN deployment model 900 configures a 5G core and a 4G core to respectively support SA users and NSA users in separate frequency bands, which is different from the network architecture 700 or 800 in which NSA users and SA users use the same frequency band. The RAN deployment model 900 allows separate uses of the resources for NSA users and SA users separated by a vertical dashed line 915, which is also different from the architecture 700 or 800 in which NSA users and SA users dynamically share the gNBs, RUs, vDUs, or vCUs.

As illustrated in FIG. 9, the RAN deployment model 900 may include one data path 911A from the NSA-RU to PDN 909A via NSA-vDU 907A, NSA-vCU-UP 905A, and SAEGW-u for NSA users 902A. RAN deployment model 900 may include another data path 911B from the SA-RU to DN 909B via SA-vDU 907B, the SA-vCU-UP 905B, and UPF for SA users 902B.

The RAN deployment model 900 may also include one control path 913A from the NSA-RU to MMB via the NSA-vDU 907A, the NSA-vCU-CP 903A, and eNB for NSA users 902A. RAN deployment model 900 may also include another control path 913B from the SA-RU to AMF via the SA-vDU 907B, the SA-vCU-CP 903B for SA users 902B.

In the RAN deployment model 900, as illustrated in FIG. 9, frequency is separated for 5G SA users and 5G NSA users in the common NR region, which leads to an impact on spectral efficiency. Also, the RAN deployment model 900 includes deployments of separate vDUs, vCUs, and RUs for 5G NSA and 5G SA, respectively, in the common NR coverage 906. Also, the RAN deployment model 900 requires three different subscriptions, e.g. 4G subscription, 5G NSA subscription, and 5G SA subscription for different users. Each subscription has its own charging or billing and access restriction, among others.

As illustrated in FIG. 9, the SA-vDU can connect to one of the SA-RUs, which may have different frequency bands. Each SA-RU connects to one SA-vDU. The NSA-vDU can connect to one of the NSA-RUs. Each NSA-RU connects to one NSA-vDU.

The RAN deployment model 900 may have handover complications. As a part of interworking, certain applications supported only in the 5G SA frequencies need to be dropped when moving to 4G NSA coverage even though the UE can support the frequency in the region.

The spectral efficiency for RAN deployment model 900 is lower than the network architecture 700 or 800 for RAN deployments. For example, when the NSA frequency is smaller, there may be frequent switchovers between primary and secondary nodes, which may reduce the UE throughput for NSA users.

FIG. 10 shows an example of computing system 1000, which can be for example any computing device making up any of the entities illustrated in FIG. 2, for example, RIC 202, or any component thereof in which the components of the system are in communication with each other using connection 1005. Connection 1005 can be a physical connection via a bus, or a direct connection into processor 1010, such as in a chipset architecture. Connection 1005 can also be a virtual, networked connection, or logical connection.

In some embodiments, computing system 1000 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

An example system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache of high-speed memory 1012 connected directly with, close to, or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of many output mechanisms known to those of skill in the art. In some instances, multimodal systems can enable a user to provide multiple types of input/output to communicate with computing system 1000. Computing system 1000 can include communications interface 740, which can generally govern and manage the user input and system output. There is no restriction on operating on any particular hardware arrangement, and therefore the basic features here may easily be substituted for improved hardware or firmware arrangements as they are developed.

Storage device 1030 can be a non-volatile memory device and can be a hard disk or other types of computer-readable media which can store data that are accessible by a computer, such as magnetic cassettes, flash memory cards, solid-state memory devices, digital versatile disks, cartridges, random access memories (RAMs), read-only memory (ROM), and/or some combination of these devices.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for interchangeably allocating radio resources between a non-standalone (NSA) network and a standalone (SA) network in an overlapping area of coverage, the method comprising:
monitoring utilization of radio resources of the SA network and the radio resources of the NSA network by a radio access network (RAN) intelligent controller (RIC);
determining that utilization of radio resources in one of the SA network or the NSA network is high by the RIC while utilization of radio resources in the other of the SA network or the NSA network has excess capacity;
reallocating radio resources from the one of the SA network or the NSA network having high radio resource utilization to the other of the SA network or the NSA network having excess capacity by the RIC.

2. The method of claim 1, wherein the utilization of the radio resources is a load on virtualized distributed units (vDUs) in the SA network and the NSA network
selecting a vDU with excess capacity from the SA network or the NSA network that has excess capacity by the RIC; and
sending a message, by the RIC, to a virtualized control unit (vCU) in the SA network or the NSA network that has excess capacity to reallocate radio resources associated with the vDU with excess capacity to the SA network or the NSA network having high radio resource utilization.

3. The method of claim 2, wherein the reallocation of radio resources associated with the vDU with excess capacity comprises allocating a portion of the frequency band utilized by the vDU with excess capacity to an updated vDU instantiated in the SA network or the NSA network having high radio resource utilization.

4. The method of claim 2, wherein the reallocation of radio resources associated with the vDU with excess capacity comprises instructing the vDU with excess capacity to switch its connection from the vCU in the SA network or the NSA network that has excess capacity to a vCU in the SA network or the NSA network having high radio resource utilization.

5. The method of claim 2, further comprising:
receiving the message from the RIC;
initiating a handover of existing sessions supported by the vDU with excess capacity in the SA network or the NSA network that has excess capacity to another vDU in the SA network or the NSA network that has excess capacity;
perform a Radio Resource Control (RRC) connection reconfiguration of the vDU with excess capacity to the SA network or the NSA network having high radio resource utilization.

6. The method of claim 1, further comprising configuring the vDU in the SA network to establish a primary connection to the vCU in the SA network and a secondary connection vCU in the NSA network, wherein the reallocation of the radio resources comprises switching the vDU in the SA network from its primary connection to the vCU in the SA network to its secondary connection to the vCU in the NSA network, whereby the secondary connection becomes an updated primary connection.

7. The method of claim 1, further comprising configuring the vDU in the NSA network to establish a primary connection to the vCUs in the NSA network and a secondary connection to the vCU in the SA network, wherein the reallocation of the radio resources comprises switching the vDU in the NSA network from its primary connection to the vCU in the NSA network to its secondary connection to the vCU in the SA network, whereby the secondary connection becomes an updated primary connection.

8. The method of claim 1, wherein monitoring utilization of radio resources of the SA network and the radio resources of the NSA network by a radio access network (RAN) intelligent controller (MC) is based upon key performance indicators (KPIs).

9. The method of claim 1, further comprising:
establishing a first data path for the SA users by connecting the SA-RU to a data network (DN) in the 5G core network through a first SA-vDU and a first SA-vCU that connects between the first SA-vDU and the DN;
establishing a second data path for the NSA users by connecting the NSA-RU to a public data network (PDN) in the 4G core network through a second SA-vDU.

10. The method of claim 1, further comprising:
establishing a first data path for the NSA users by connecting the NSA-RU to a PDN in the 4G core network through a first NSA-vDU and a first SA-vCU that connects between the first SA-vDU and the PDN; and
establishing a second data path for the SA users by connecting the SA-RU to a DN in the 5G core network through a second NSA-vDU.

11. A system comprising:
a storage device configured to store instructions;
a processor configured to execute the instructions and cause the processor to:
monitor utilization of radio resources of the SA network and the radio resources of the NSA network by a radio access network (RAN) intelligent controller (RIC),
determine that utilization of radio resources in one of the SA network or the NSA network is high by the RIC while utilization of radio resources in the other of the SA network or the NSA network has excess capacity, and
reallocate radio resources from the one of the SA network or the NSA network having high radio resource utilization to the other of the SA network or the NSA network having excess capacity by the RIC.

12. The system of claim 11, wherein the processor is configured to execute the instructions and cause the processor to:
select a vDU with excess capacity from the SA network or the NSA network that has excess capacity by the RIC; and
send a message, by the RIC, to a vCU in the SA network or the NSA network that has excess capacity to reallocate radio resources associated with the vDU with excess capacity to the SA network or the NSA network have high radio resource utilization.

13. The system of claim 11, wherein the processor is configured to execute the instructions and cause the processor to configure the vDU in the SA network to establish a primary connection to the vCU in the SA network and a secondary connection vCU in the NSA network, wherein the reallocation of the radio resources comprises switching the vDU in the SA network from its primary connection to the vCU in the SA network to its secondary connection to the vCU in the NSA network, whereby the secondary connection becomes an updated primary connection.

14. The system of claim 11, wherein the processor is configured to execute the instructions and cause the processor to configure the vDU in the NSA network to establish a primary connection to the vCUs in the NSA network and a secondary connection to the vCU in the SA network, wherein the reallocation of the radio resources comprises switching the vDU in the NSA network from its primary connection to the vCU in the NSA network to its secondary connection to the vCU in the SA network, whereby the secondary connection becomes an updated primary connection.

15. The system of claim 11, wherein monitoring utilization of radio resources of the SA network and the radio resources of the NSA network by a radio access network (RAN) intelligent controller (RIC) is based upon KPIs.

16. A non-transitory computer-readable medium comprising instructions, the instructions, when executed by a computing system, cause the computing system to:
monitor utilization of radio resources of the SA network and the radio resources of the NSA network by a radio access network (RAN) intelligent controller (RIC);
determine that utilization of radio resources in one of the SA network or the NSA network is high by the RIC while utilization of radio resources in the other of the SA network or the NSA network has excess capacity; and
reallocate radio resources from the one of the SA network or the NSA network having high radio resource utilization to the other of the SA network or the NSA network having excess capacity by the RIC.

17. The computer-readable medium of claim 16, wherein the computer-readable medium further comprises instructions that, when executed by the computing system, cause the computing system to:
select a vDU with excess capacity from the SA network or the NSA network that has excess capacity by the RIC; and
send a message, by the RIC, to a vCU in the SA network or the NSA network that has excess capacity to reallocate radio resources associated with the vDU with excess capacity to the SA network or the NSA network have high radio resource utilization.

18. The computer-readable medium of claim 16, wherein the computer-readable medium further comprises instructions that, when executed by the computing system, cause the computing system to configure the vDU in the SA network to establish a primary connection to the vCU in the SA network and a secondary connection vCU in the NSA network, wherein the reallocation of the radio resources comprises switching the vDU in the SA network from its primary connection to the vCU in the SA network to its secondary connection to the vCU in the NSA network, whereby the secondary connection becomes an updated primary connection.

19. The computer-readable medium of claim 16, wherein the computer-readable medium further comprises instructions that, when executed by the computing system, cause the computing system to configure the vDU in the NSA network to establish a primary connection to the vCUs in the NSA network and a secondary connection to the vCU in the SA network, wherein the reallocation of the radio resources comprises switching the vDU in the NSA network from its primary connection to the vCU in the NSA network to its secondary connection to the vCU in the SA network, whereby the secondary connection becomes an updated primary connection.

20. The computer-readable medium of claim 16, monitoring utilization of radio resources of the SA network and the radio resources of the NSA network by a radio access network (RAN) intelligent controller (RIC) is based upon KPIs.
